(19) United States
(12) Patent Application Publication
(10) Pub. No.: US 2018/0124047 A1
(43) Pub. Date: May 3, 2018

(54) High Assurance Remote Identity Proofing

(71) Applicants: David L Fisher, Fort Mill, SC (US); Michael S McClain, Basking Ridge, NJ (US); Jesse C Skrivseth, Missoula, MT (US); Jorge A Rivera, Ashburn, VA (US)

(72) Inventors: David L Fisher, Fort Mill, SC (US); Michael S McClain, Basking Ridge, NJ (US); Jesse C Skrivseth, Missoula, MT (US); Jorge A Rivera, Ashburn, VA (US)

(21) Appl. No.: 15/796,914

(22) Filed: Oct. 30, 2017

Related U.S. Application Data
(60) Provisional application No. 62/415,234, filed on Oct. 31, 2016.

(51) Int. Cl. H04L 29/06; G06K 9/00; G06F 21/50

(52) U.S. Cl. CPC H04L 63/0861; G06K 9/00241; G06Q 50/01; G06F 21/50; G06K 9/00892; H04L 63/0853

(57) ABSTRACT

Remote identity proofing is the process of uniquely verifying an individual who is a party to an online transaction. This presents an enormous challenge to the secure delivery of government services as well as online commerce. The degree of difficulty is compounded when attempting to remotely authenticate for the first time a previously unknown individual. The High Assurance Remote Identity Proofing method introduces a holistic approach to solving this problem. A rich collection of identity data, when evaluated by multiple verification methods, can be aggregated to an identity assurance score, which is a measure of the uniqueness and authenticity of a claimed identity and ultimately provides a high assurance that someone attempting to remotely verify his or her identity is who he or she claims to be.

### CROSS REFERENCE TO RELATED APPLICATIONS

This patent application claims the benefit of provisional patent application No. 62/415,234 filed on Oct. 31, 2016.

### FIELD OF INVENTION

Remote identity proofing is the process of uniquely verifying the identity of an individual who is party to an online transaction. The invention is a method of aggregating verified identity attributes from multiple sources into an identity assurance scorecard that uniquely and positively identifies an individual.

The target market for remote proofing services is very broad, including practically any company or organization attempting to establish a relationship with a prospective customer or user with whom there is no prior association. Specific examples include opening a financial account online, visitor pre-registration, requesting online Government services.

The obvious risk to these organizations is exposing their systems, data, and services to those who are not who they claim to be. The risk is further exacerbated by regulatory mandates (e.g., Anti-Money Laundering and Know-Your-Customer) that require institutions to more diligently ensure that their products and services are not being misused, or worse, being used to circumvent the law or bring harm to the public.

### Related Applications

System and Method for Strong Remote Identity Proofing

| | | |
|---|---|---|
| US20120191621 | Aug. 2, 2010 | Anakam, Inc. |

Systems and Methods Utilizing Facial Recognition and Social Network Information Associated with Potential Customers

| | | |
|---|---|---|
| US20120278176 | Apr. 27, 2011 | Amir Naor |

Methods and Systems for Identifying, Verifying, and Authenticating an Identity

| | | |
|---|---|---|
| US20140331282 | May 1, 2013 | Dmitri Tkachev |

Identity Validation and Verification System and Associated Methods

| | | |
|---|---|---|
| U.S. Pat. No. 8,984,282 | May 21, 2013 | James F. Kragh |

Systems and Methods for Verifying Identities

| | | |
|---|---|---|
| US20140331278 | Dec. 5, 2013 | Dmitri Tkachev |

Analyzing Facial Recognition Data and Social Network Data for User Authentication

| | | |
|---|---|---|
| U.S. Pat. No. 9,147,117 B1 | Jun. 11, 2014 | Socure Inc |

Method and Apparatus for Remote Identity Proofing Service Issuing Trusted Identities

| | | |
|---|---|---|
| U.S. Pat. No. 9,491,160 | Nov. 23, 2015 | Michigan Health Information |
| | | Network-Mihin |

Risk Assessment Using Social Networking Data

| | | |
|---|---|---|
| U.S. Pat. No. 9,558,524 | Mar. 23, 2016 | Socure Inc. |

### Federal Sponsored R&D

Partial funding is provided by the U.S. Department of Homeland Security SBIR program.

### BACKGROUND OF THE INVENTION

Accurately verifying the identity of an individual is critical in online applications. An individual's entitlement to perform a particular transaction or access specific information hinges on the assurance that the individual in question is indeed who he or she claims to be. Various ineffective processes have been historically used for the purpose of ascertaining the identity of an individual, with most of them relying on a trusted authority to vouch for that individual's claimed identity. This approach does not lend itself well to automated, remote online authentication. Another common technique utilizes knowledge about an individual that is assumed to be private and readily available only to the individual in question, but these knowledge-based methods have come into question through the very significant amount of presumably private or confidential information that has been compromised through countless data breaches. In the vast majority of cases, organizations tend to focus on implementing only a single technique for identity verification and fail to realize the more accurate and comprehensive approach of combining results from many identity verification methods.

### SUMMARY OF THE INVENTION

The invention is an identity verification process through which multiple identity data elements are collected, verified, evaluated, and scored to provide a high assurance that the identity of the individual has been correctly ascertained and corresponds to the actual person. This is accomplished by piecing together identity attributes obtained from multiple identity verification methods and sources. These identity verification sources are specialized services that rely on publicly available data from authoritative sources, and proprietary algorithms and processes developed from extensive identity management and fraud detection techniques. The verification methods and sources may have different degrees of accuracy and reliability. In aggregate though, the resulting rich mosaic of data provides mutual reinforcement of coincident attributes to strengthen the confidence in and assurance of the identity. Verification results are evaluated and summarized in the form of an identity assurance scorecard.

Likely use cases include:
Secure delivery of Government services (e.g., Social Security, IRS, FAFSA)
Verify applicants that request use of Government assets or resources
Financial services; recent Know-Your-Customer and Anti-Money Laundering mandates are requiring that banks be more diligent in opening new accounts
Consumer-to-consumer markets, such as auctions and dating sites that have requirements to verify subscribers
Pre-registration of visitors prior to their arrival with the objective of streamlining time-consuming onsite processing and check-in with identity verification that can be completed remotely
Education market applications to identify participants in online/remote coursework or testing
Elevated trust in users with existing accounts who engage in higher-risk interactions, such as wire transfers or changes of address on file
Specialized Department of Defense and Federal identity applications including: privileged identity management, secure communication, password alternatives, and common access card or personal identity verification card replacement

### BRIEF DESCRIPTION OF THE DRAWINGS

FIG. 1 illustrates the sequence of steps that generate an identity assurance score.

FIG. 2 illustrates collection of enrollment data.

FIG. 3 illustrates the aggregation of identity data hum multiple verification services.

FIG. 4 illustrates that much of the process, including evaluation and scoring, is configurable by each organization.

FIG. 5 illustrates components of the identity assurance scorecard.

### DETAILED DESCRIPTION OF THE INVENTION

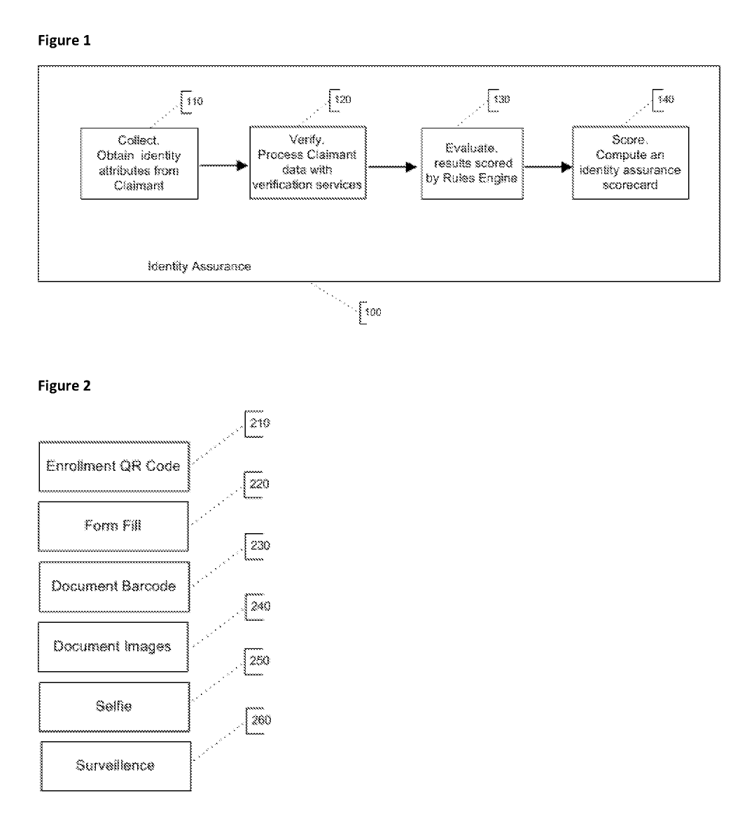

The method and system collect, verify, evaluate, and score multiple identity attributes to ensure that a person who claims a particular identity (Claimant) is, in fact, that person. When these steps are executed in sequence (FIG. 1), the result is a complete, verified, and trusted identity supported by a rich array of information about that specific individual, that enhancing trust and confidence about that individual's true identity.

The four-step process begins by collecting claimed identity attributes [110] and then verifying this data set through multiple verification services [120]. The results returned from the verification services are evaluated [130] according to the previously configured rules. This output computes to an identity assurance scorecard [140] which is a proprietary relative measure of the confidence that the identity claimed is true and accurate.

Collect

The initial step is to collect identity attributes from the Claimant. These attributes include frequently disclosed personal attributes such as names, address, gender, or date of birth. Biometric data also collected includes: fingerprints, face image, and voice recording. Images of government issued documents, as well as select non-personal attributes will also be captured. The exact mix of collected attributes is configurable to meet the requirements of the end-using organization seeking to ascertain the identity of the Claimant.

Identity data collection occurs as a result of form fill, interviews, observations, referrals, and other means. Some information is gathered in a structured manner; for example, Claimant is prompted to capture an image of the front and back of Claimant's driver's license. Biometric collection is also a structured exercise, wherein applicant is prompted to pose for selfie or fingerprint capture.

Other identity data is collected with only limited Claimant awareness. For example, GPS location, IP address, or device/session identifiers (MAC Address, browser ID, etc.) data is collected through a browser or the Claimant's mobile device.

FIG. 2 illustrates a typical enrollment session which is initiated by scanning a QR Code [210]. The Claimant may be prompted for basic data attributes [220]. Claimant is also prompted to scan the barcode [230] of a government issued identification document. The same document is also imaged [240 ] for OCR and face matching to the collected selfie [250]. Finally, some data elements are collected surreptitiously [260].

A more accurate identity assurance score is achieved as a result of the greater number of collected attributes of a specific individual. More data points allow for extended cross verification. Each verification element further adds to the richness of the identity being confirmed. It is important to note that the identity attributes do not necessarily have to be collected all at once. Collecting additional identity attributes over time and/or reconfirming previously captured data elements can also be very effective in maintaining a high level of confidence that the claimed identity is authentic.

Verify

The collected attributes are then independently verified. This data confirmation is accomplished by submitting the attributes to a number of identity verification processes. Additionally, these verification processes also seed the collection of additional identity information, which results in a higher likelihood the Claimant is who he or she claims to be.

Multiple, overlapping methods are used for verification and enrichment. Some identity attributes are verified and enriched through specially developed application programming interfaces (APIs) which access outside databases and/or other authoritative data sources. In other cases, special-use or restricted access services are invoked to meet this requirement.

As an example, consider a service that verifies an individual's home phone number. To invoke this verification process, the Claimant data is prepared and submitted to the service. The service sends back a response that is received and interpreted. Preparation involves packaging the data in a format expected by the service. In this example, the format requirement is [xxx-xxx-xxxx][LAST, FIRST]. Transmission is via secure SSH and the expected response is a simple TRUE/FALSE.

Expanding on this example, consider that in addition to confirming the Claimant's phone number, the verification service also returns the matching home address. This newly collected additional identity attribute is used to further build the verified identity by comparing it to the home address listed on the Claimant's driver's license. Layering these interconnected identity data elements and then cross checking to multiple identity verification services yields a higher identity assurance score.

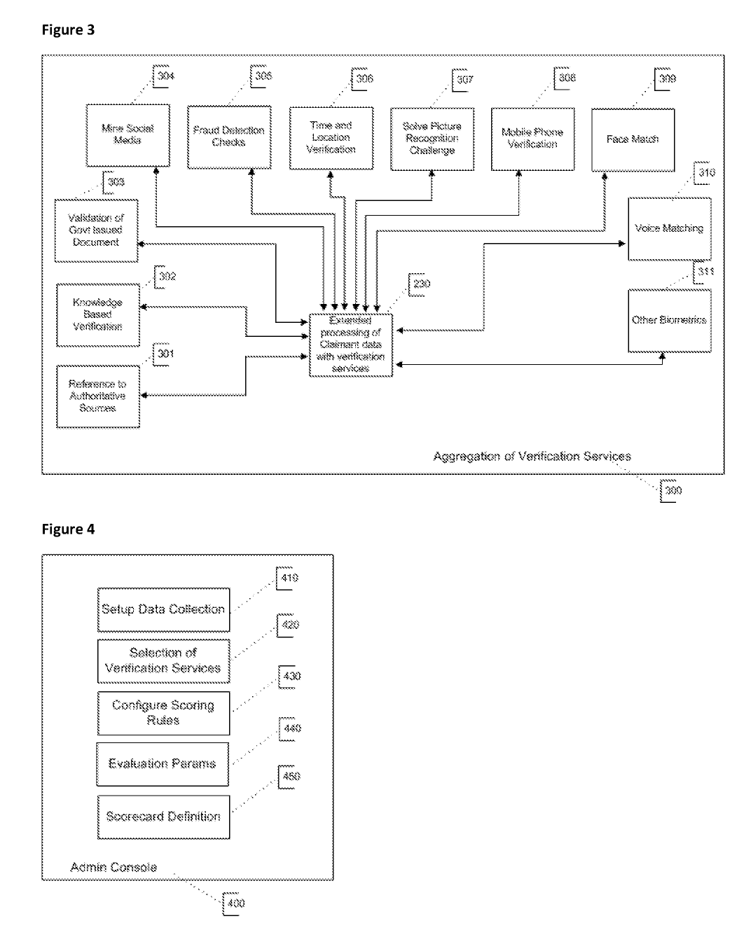

FIG. 3 illustrates that the aggregation of multiple verification services [300] yields a richer identity verification. Some of the preferred verification services include:
Reference to Authoritative Sources [301]—Matching Claimant data to an official source such as Social Security or death records
Knowledge-Based-Verification [302]—Claimant is challenged with questions to which, presumably, only he or she would know the answer
Validation of Government-Issued Documents [303]—Document scanning techniques perform counterfeit checks by comparing drivers' licenses and passports to official document templates
Mining Social Media [304]—Gathering and examining data from individual accounts such as Facebook, LinkedIn, and others; forensic investigation isolates inconsistencies and potentially manufactured identities
Fraud Detection Checks [305]—Reviews Claimant-provided data for indicators of fraud; related behavior checks and supporting data from other data sources also exposes fraudulent data
Time and Location Verification [306]—Performs geolocation using IP/MAC address from Claimant's device; evaluates for consistency with other provided data
Solve Picture Recognition Challenge [307]—Includes recognizing a scene close to one's claimed home address or photos that have been tagged from one's social media
Mobile Phone Verification [308]—Claimant's mobile phone offers an increasing number of options for verification such as out-of-band SMS or voice call verification
Face Detection and Matching [309]—Compare live facial image to authenticated photo sourced from a driver's license, other official documents, or social media
Voice Matching [310]—Conducts Claimant voice analysis and comparison; combined with face detection resulting in a short selfie video, this method is extremely difficult to compromise
Other Biometrics [311]—Includes fingerprint matching, behavior checking, gestures, or other uniquely distinguishing characteristics

Evaluate

Results from the identity verification services are now evaluated. Raw responses that are returned require translation or other interpretation in order to be meaningful. Some responses are simply a True/False check of a verification attribute. Other responses are less precise, such as a percent likelihood that a Claimant selfie matches to the photo from Claimant's driver's license. Still other verification services responses return a rich fabric of data which in turn is parsed into separate streams, each to be separately verified.

Upon completion of all the prescribed verification process, dozens of collected and discovered data attributes, each with corresponding verification results, are compiled for the specific identity. Note that verification results may consist of attributes that are evaluated favorably (i.e., have a high assurance of being genuine) and attributes that, when evaluated, call into question the authenticity of the claimed identity. The evaluation process examines if un-verified attributes point to a single deficiency (e.g., Claimant has misrepresented his or her age), or if the entire identity appears to have been manufactured.

An evaluation rule is the result of a specific test applied to a set of identity data. A rule might be a simple Boolean evaluation, such as “Does the Claimant's IP address originate from a high-risk country?” Alternatively, a rule could be a qualitative comparison, such as “How likely is it that the driver's license photo and the submitted selfie display the same face?”

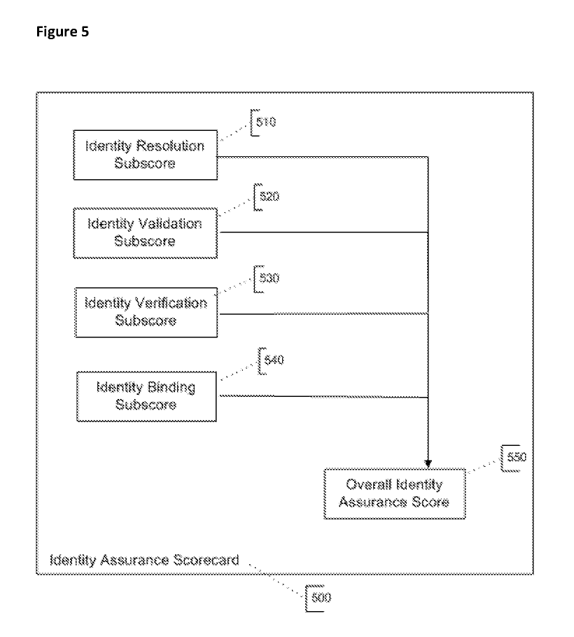

The evaluation process is flexible and configurable based on the unique business needs or requirements of the end-using organization. Online web tools are made available to empower the organization to manage all the identity information under its control. These tools, shown in FIG. 4: Admin Console [400], allow for the configuration of identity data collection, processing, and scoring. The initial setup [410] includes options for how the services are to be integrated and made available to the Claimant. Selection of verification services [420] will determine which processes are active for each organization.

Rule configuration [430] empowers each administrator to prescribe how the identity assurance score is to be computed. This may consist of fine tuning existing rules or creating entirely new rules. Additional evaluation parameters [440] will enable tuning of the model through rule prioritization and weighting. Using proprietary machine learning techniques, many of the settings are automatically re-calibrated and optimized over time. Another configurable component is the identity assurance scorecard definition [450].

Score

Evaluation results are compiled and then scored across several categories. The outcome of this exercise is a unique report referred to as a “scorecard”. An identity assurance scorecard, which gives organizations an important quantitative tool with which to measure the overall authenticity of the Claimant's identity. It also can provide valuable insight into detailed components of the identity.

At a minimum, the scorecard will include scoring in four categories that are consistent with National Institute of Standards and Technology (NIST) standards for identity proofing. These scoring categories shown in FIG. 5 are:
[510] Identity Resolution—Resolve a claimed identity to a single, unique identity
[520] Identity Validation—Validate that the evidence is true and authentic
[530] Identity Verification—Verify that the claimed identity exists in the real world
[540] Identity Binding—Confirm that the claimed identity is associated with the real person

Finally, scoring is condensed to a single identity assurance number or score [550] for easier comparison and evaluation. The range of acceptable scores is established by the end-using organization for its own use case. For highly sensitive applications, a higher score is required for the identity to be accepted as genuine. In other less rigorous cases, a lower threshold is set. Organizations might also be particularly focused on one specific component of the identity (e.g., age or appearance). The identity assurance scorecard is customized for those use cases.

In addition to the above scorecard, organizations may optionally retrieve more detailed data as it was collected and verified. Some organizations will have a valid business case for obtaining/archiving this data. These organizations will want to review each scorecard and in some cases archive Claimant's enrollment data. For example, the image of the Claimant's driver's license is something that an organization may need for future use.

Organizations can opt to repeat these identity assurance steps in the future as additional or updated identity information becomes available. This continuous vetting process is an effective way to maintain high assurance over time.

What is claimed is a:

1. A computer implemented method for verifying an individual's claimed identity by aggregating multiple personal identity attributes comprising the following steps:
Collecting by a camera-enabled and network-connected access device, personally identifiable attributes from an individual claiming a specific identity (Claimant);
Verifying, by the computer processor, Claimant data by transmitting the collected identity attributes to multiple identity verification services;
Evaluating, by the computer processor, the responses that are returned from the identity verification services;
Scoring, by the computer processor, the identity verification responses and their subsequent evaluations into an identity assurance scorecard that is unique for each Claimant;

2. Method of claim 1 wherein the personal identity attribute data is collected through a mobile application or an Internet browser session;

3. Method of claim 1 wherein the collected personal identity attributes are provided by the Claimant and include some or all of this data: home address, phone number(s), email address(es), Social Security number, image(s) of Government-issued credential(s), selfie, and other biometrics;

4. Method of claim 1 wherein the collected personal identity data elements are obtained by surreptitious means to include some or all of this information: mobile phone number, session IP address, GPS location, MAC address, gestures, and other device forensics;

5. Method of claim 1 wherein the set of collected data elements required of the Claimant can be customized for each organization;

6. Method of claim 1 wherein the identity verification services include some or all of the following information: face-matching metrics, IP address location, public records search, driver's license validation, Social Security number matching, social media mining, and pulling Claimant's credit file;

7. Method of claim 1 wherein the identity verification services may be API services, internal database matches, or comparison to authoritative data sources;

8. Method of claim 1 wherein the responses from verification services are evaluated according to configurable scoring rules;

9. Method of claim 1 wherein said configurable rules can be customized according to relevance, priority, consistency with other responses, or an organization's specific business case;

10. Method of claim 1 wherein the identity assurance scorecard includes at least some of these identity assurance categories: uniqueness, liveness/existence, authenticity, resolution, validation, verification, and binding;

11. Method of claim 1 wherein the identity assurance scorecard information is condensed into a single identity assurance score that is a concise and relative measure of identity confidence;

12. Method of claim 1 wherein the identity can be enriched over time as more information becomes available;

13. Method of claim 1 as used for remote identity proofing when the Identity Proofer has no prior relationship with the Claimant;

14. Method of claim 1 as used for visitor pre-registration/enrollment and background check confirmation.
